(19) United States
(12) Patent Application Publication
(10) Pub. No.: US 2007/0104046 A1
(43) Pub. Date: May 10, 2007

(54) Optical pickup device

(75) Inventor: Makoto Horiyama, Nara-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/592,045

(22) Filed: Nov. 1, 2006

(30) Foreign Application Priority Data
Nov. 1, 2005 (JP) 2005-318873

(51) Int. Cl. G11B 7/00

(52) U.S. Cl. 369/44.23; 369/112.01

(57) ABSTRACT

In order to (i) reduce astigmatism due to a diffraction grating capable of compensating light intensity distribution of a light beam emitted by a light source and (ii) simplify fabrication processes, an optical pickup device of the present invention includes: a semiconductor laser 1; a collimator lens 4; a diffraction grating 3 capable of changing light intensity distribution of a light beam emitted by the semiconductor laser 1; a polarizing beam splitter 5 for causing a laser beam reflected by an optical disc 8 to be directed in a direction different from a direction of the light beam emitted by the semiconductor laser 1; and a parallel plate 2 for compensating astigmatism due to the diffraction grating 3, the parallel plate 2 being provided between the semiconductor laser 1 and the collimator lens 4 so as to be inclined to an optical axis of the semiconductor laser 1.

This non-provisional application claims priority under 35 U.S.C. §119(a) on Patent Application No. 318873/2005 filed in Japan on Nov. 1, 2005, the entire contents of which are hereby incorporated by reference.

### FIELD OF THE INVENTION

The present invention relates to an optical pickup device used in recording/reading information to/from an optical recording medium such as an optical disc. The present invention particularly relates to an optical pickup device capable of improving astigmatism due to a diffraction grating which can change light intensity distribution of a light beam emitted by a semiconductor laser.

### BACKGROUND OF THE INVENTION

Recently, in order to increase the density and capacity of the information storage capacity of an optical recording medium, such as an optical disc for recording high-quality moving image or the like, there is required an optical pickup device capable of forming a minute spot of a light beam on the optical recording medium.

Patent Citation 1: Japanese Unexamined Patent Publication No. 134972/2001 (Tokukai 2001-134972; published on May 18, 2001, page 7, FIG. 1) for example discloses a method in which: in order to form a minute spot of a light beam on an optical recording medium, light intensity distribution of a light beam emitted by a light source is compensated by a diffraction grating, so that RIM intensity of a light beam incident to an objective lens, namely, light intensity at a peripheral portion of a lens with respect to light intensity at a central portion of the lens is improved.

With reference to FIG. 15, the following explains a conventional optical pickup device described in Patent Citation 1. In the optical pickup device, a holographic diffraction grating 102 provided on a transmissive element 103 is arranged so that a grating groove width of an area which transmits a light flux constituting the central portion of a laser light flux emitted by a semiconductor laser light source 101 is different from a grating groove width of an area which transmits a light flux constituting a peripheral portion of the laser light flux. Consequently, light intensity distribution of 0 order diffraction light of laser light emitted by the semiconductor laser light source 101 is controlled.

Namely, the laser light flux emitted by the semiconductor laser light source 101 passes through the transmissive element 103 on which the holographic diffraction grating 102 is provided, so that light intensity distribution 104 of the laser light flux is compensated as illustrated in FIG. 15. Then, the laser light flux is emitted from a semiconductor laser module. Consequently, light intensity distribution of the laser light flux incident to an objective lens is compensated from 105 to 106 for example. Thereafter, the laser light flux is irradiated onto an optical disc through the objective lens. That is, by improving RIM intensity of the laser light flux incident to the objective lens, a minute light spot is formed on the optical disc.

However, in the optical pickup device described in Patent Citation 1, an influence of astigmatism due to a shape of the holographic diffraction grating 102 used to correct light intensity distribution of a light beam emitted by the semiconductor laser light source 101 is not considered. In other words, it is obvious that the conventional holographic diffraction grating 102 generates astigmatism due to a shape of a grating groove, which prevents emitted light having passed through the objective lens from forming a minute light spot on the optical disc, so that quality of a reproduction signal deteriorates and amplitude of a tracking error signal drops.

Note that, “astigmatism” is such an aberration that a position where a point is imaged on a screen in concentric-circle direction (Meridional direction) with respect to an optical axis is different from a position where the point is imaged on the screen in a radial direction (Sagittal direction) with respect to the optical axis, so that the point cannot be imaged as a point. To be more specific, “astigmatism” is aberration in which an optical system such as a lens and a mirror cannot image a point as a point but image the point as two lines with a certain distance between them.

Further, as a method for improving astigmatism due to a converging optical system in an optical pickup device, Patent Citation 2: Japanese Unexamined Patent Publication No. 4915/2005 (Tokukai 2005-4915; published on Jan. 6, 2005, page 10, FIG. 1) proposes a method in which an astigmatism compensating element is used. With reference to FIG. 16, the following explains a conventional optical pickup device described in Patent Citation 2.

A light beam emitted by a laser light source 201 passes through an astigmatism compensating element 202 included in a holder 203, and is irradiated by an objective lens 207 onto an optical disc 208 through a polarizing beam splitter 205, ¼ wavelength plate 206, a collimator lens 210, and a reflecting mirror 204. Then, the light beam reflected by the optical disc 208 is incident to the polarizing beam splitter 205 through the objective lens 207, the collimator lens 210, and the ¼ wavelength plate 206. Further, the light beam incident to the polarizing beam splitter 205 changes its traveling direction by 90 degrees and is received by a light detecting device 211 through a detecting lens 209.

Here, the light beam passes through the astigmatism compensating element 202, and is given astigmatism having a predetermined size and a predetermined direction. Note that, astigmatism due to a whole optical system in the optical pickup device is a sum of all astigmatisms due to optical elements.

As described above, in the conventional optical pickup device described in Patent Citation 2, the astigmatism compensating element 202 is provided so as to correct astigmatisms due to optical elements other than the astigmatism compensating element 202.

However, the optical pickup device in Patent Citation 2 has the following problems.

First, in the optical pickup device in Patent Citation 2, a diffraction grating for compensating light intensity distribution is not taken into consideration, so that it is impossible to form a minute spot of a light beam on the optical disc 208.

Further, in order to reduce the astigmatism which is the sum of astigmatisms due to the optical elements, the astigmatism compensating element 202 is subjected to positional adjustment in an optical axis direction and is subjected to rotational angle adjustment around the optical axis, so that astigmatism with a predetermined size and a predetermined direction is given to the light beam. That is, in order to cause the astigmatism compensating element 202 to generate predetermined astigmatism, the astigmatism compensating element 202 must be adjusted with respect to two axes. Consequently, fabrication of an optical pickup device gets complex.

### SUMMARY OF THE INVENTION

The present invention was made in view of the foregoing problems. An object of the present invention is to provide an optical pickup device, which allows for (i) reducing astigmatism due to a diffraction grating capable of compensating light intensity distribution of a light beam emitted by a light source and (ii) simplifying fabrication processes of the optical pickup device.

In order to achieve the foregoing object, the optical pickup device of the present invention is an optical pickup device, including: a light source; a collimator lens; a diffraction element capable of changing light intensity distribution of a light beam emitted by the light source; and light splitting means for causing a light beam reflected by an optical recording medium to be directed in a direction different from a direction of the light beam emitted by the light source, said optical pickup device further including a light transmitting member for compensating astigmatism due to the diffraction element, the light transmitting member being provided between the light source and the collimator lens so as to be inclined to an optical axis of the light source.

With the arrangement, the light transmitting member for compensating astigmatism due to the diffraction element is provided so as to be inclined to the optical axis of the light source.

Consequently, when the light beam emitted by the light source is incident to the light transmitting member, it is possible to give predetermined astigmatism to the light beam. That is, the light transmitting member is inclined to the optical axis, so that it is possible to generate new astigmatism for compensating the astigmatism due to the diffraction element. Therefore, it is possible to cancel the astigmatism due to the diffraction element by using the new astigmatism due to the light transmitting member. Consequently, the astigmatism due to the diffraction element can be cancelled. In other words, it is possible to reduce an influence of the astigmatism due to the diffraction element. Therefore, it is possible to converge the light beam on an optical recoding medium as a minute light spot, so that it is possible to prevent deterioration in quality of a reproduction signal recorded in the optical recording medium or to prevent drop of an amplitude of a tracking error signal.

Further, with the arrangement, the light transmitting member is provided between the light source and the collimator lens. Consequently, a light beam is given astigmatism by the light transmitting member and then is changed to collimated light. Therefore, there is no possibility that the light beam diffuses out of the diffraction element, so that it is possible to correct astigmatism due to the diffraction element without reducing energy of the light beam.

Further, the light transmitting member is inclined so as to generate predetermined astigmatism, so that it is possible to fabricate an optical pickup deice with a simpler process than a conventional process in which a light transmitting member is subjected to positional adjustment in an optical axis direction and to rotational adjustment around the optical axis, that is, the light transmitting member is adjusted with respect to two axes.

Consequently, it is possible to reduce astigmatism due to the diffraction grating capable of compensating light intensity distribution of a light beam emitted by a light source and to provide an optical pickup device allowing for a simpler fabrication process.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a cross sectional drawing of an embodiment of an optical pickup device of the present invention.

FIG. 2 is an explanatory drawing for illustrating a pattern of a diffraction element used in the optical pickup device.

FIG. 3(a) is an explanatory drawing for illustrating light intensity distribution at a time when a diffraction grating is not provided in the optical pickup device.

FIG. 3(b) is an explanatory drawing for illustrating light intensity distribution at a time when a diffraction grating is provided in the optical pickup device.

FIG. 4 is a graph for illustrating a relation between an inclination of a parallel plate and an amount of astigmatism in the optical pickup device.

FIG. 5 is a cross sectional drawing of another embodiment of the optical pickup device of the present invention.

FIG. 6 is an explanatory drawing for illustrating a pattern of a diffraction element used in the optical pickup device.

FIG. 7(a) is an explanatory drawing for illustrating light intensity distribution at a time when a diffraction grating is not provided in the optical pickup device.

FIG. 7(b) is an explanatory drawing for illustrating light intensity distribution at a time when a diffraction grating is provided in the optical pickup device.

FIG. 8 is a cross sectional drawing of further another embodiment of the optical pickup device of the present invention.

FIG. 9 is a cross sectional drawing for illustrating a device.

FIG. 10 is a cross sectional drawing for illustrating further another embodiment of the optical pickup device of the present invention.

FIG. 11 is a cross sectional drawing for illustrating further another embodiment of the optical pickup device of the present invention.

FIG. 12 is a cross sectional drawing for illustrating further another embodiment of the optical pickup device of the present invention.

FIG. 13 is a cross sectional drawing for illustrating further another embodiment of the optical pickup device of the present invention.

FIG. 14 is a cross sectional drawing for illustrating a structure of a second polarization diffraction element in the optical pickup device.

FIG. 15 is a cross sectional drawing of a conventional optical pickup device.

FIG. 16 is a cross sectional drawing of an optical pickup device which includes a conventional astigmatism compensating element.

### DESCRIPTION OF THE EMBODIMENTS

### Embodiment 1

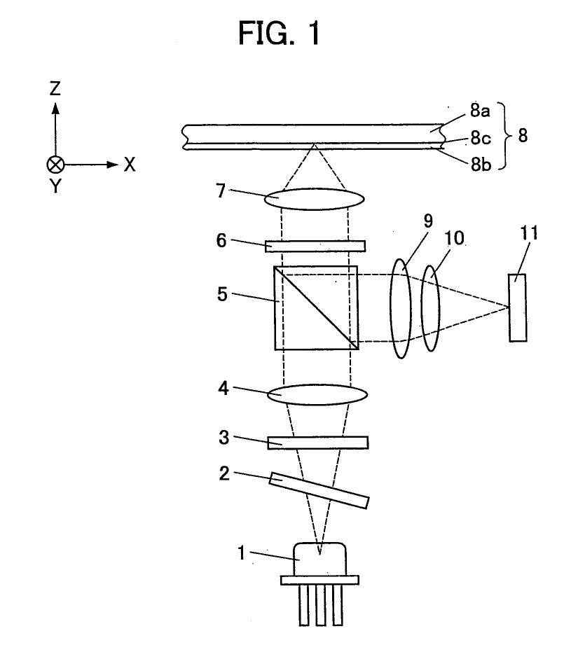

The following explains an embodiment of the present invention with reference to FIGS. 1 to 4.

FIG. 1 illustrates a structure of an optical pickup device of the present embodiment. As illustrated in FIG. 1, the optical pickup device of the present embodiment includes a semiconductor laser (light source) 1, a parallel plate (light transmitting member) 2, a diffraction grating (diffraction element) 3, a collimator lens 4, a polarizing beam splitter 5, a ¼ wavelength plate 6, an objective lens 7, a converging lens 9, a cylindrical lens 10, and a photo detector 11. In FIG. 1, an optical axis direction is regarded as a Z direction, and directions perpendicular to the Z direction are regarded as X and Y directions.

First, with reference to FIG. 1, the following explains a light path of a light beam emitted by the semiconductor laser 1 of the optical pickup device of the present embodiment. For convenience of explanation, FIG. 1 illustrates only a periphery of a light beam by use of broken lines.

A light beam with linear polarization is emitted by the semiconductor laser 1 which is a light source and is incident to the diffraction grating 3 through the parallel plate 2 which is transparent. In the diffraction grating 3, light intensity distribution of the light beam changes and zero order diffraction light and ± first order diffraction light are generated so as to generate a tracking error signal.

Then, the light beam passes through the collimator lens 4 so as to be collimated light, and then is incident to the polarizing beam splitter 5. The light beam is emitted by the polarizing beam splitter 5 and then is incident to the ¼ wavelength plate 6 and is converted into a light beam with circular polarization.

The light beam is emitted by the ¼ wavelength plate 6 and is converged on the optical disc 8 through the objective lens 7. At that time, the zero order diffraction light forms a main spot on the optical disc 8 and the ± first order diffraction light forms two sub spots on the optical disc 8.

Next, the light beam incident to the optical disc 8 is reflected by the optical disc 8 so as to be reflected light, which is incident to the ¼ wavelength plate 6 through the objective lens 7 again. The reflected light with circular polarization is converted by the ¼ wavelength plate 6 into a linearly polarized light whose polarization direction is perpendicular to that of the emitted light which is a light beam from the semiconductor laser 1.

The reflected light is incident to the polarizing beam splitter 5. At that time, as described above, the reflected light has polarization direction perpendicular to that of the emitted light, so that the reflected light is reflected by the polarizing beam splitter 5. Then, the reflected light reflected by the polarizing beam splitter 5 is converged by the converging lens 9 and then is received by the photo detector 11 through the cylindrical lens 10.

The following explains a structure of each section of the optical pickup device of the present embodiment and the optical disc 8.

The semiconductor laser 1 is a light source for emitting a light beam with linear polarization. A wavelength of the light beam is not particularly limited.

The parallel plate 2 is a light transmitting member, having two parallel planes, for compensating astigmatism due to the diffraction grating 3. That is, the parallel plate 2 generates astigmatism for compensating the astigmatism due to the diffraction grating 3. The parallel plate 2 is not particularly limited as long as it is made of a light transmitting material.

Further, the parallel plate 2 is provided between the semiconductor laser 1 and the diffraction grating 3 so as to be inclined to an optical axis of the semiconductor laser 1. That is, the parallel plate 2 is provided so that planes to which a light beam is incident, namely, two parallel planes, are inclined to an optical axis of a light beam emitted by the semiconductor laser 1. An angle at which the parallel plate 2 is inclined to the optical axis will be mentioned later.

The diffraction grating 3 changes light intensity distribution of light emitted by the semiconductor laser 1. That is, the diffraction grating 3 corrects light intensity distribution of a light beam incident to the objective lens 7. Consequently, when a light beam having passed through the objective lens 7 converges on the optical disc 8, it is possible to form a small light spot of the light beam on the optical disc 8.

Further, the diffraction grating 3 generates a tracking error signal. Consequently, it is possible to generate not only zero order diffraction light but also ± first order diffraction light for a tracking error signal. Therefore, accuracy in a tracking control increases. A structure of the diffraction grating 3 will be mentioned later.

The collimator lens 4 changes a light beam emitted by the semiconductor laser 1 to collimated light.

The polarizing beam splitter 5 transmits light with predetermined linear polarization and reflects light with linear polarization which is obtained by turning the light with predetermined linear polarization by 90 degrees. Consequently, it is possible to separate a path of reflected light, which is a light beam reflected by the optical disc 8, from a path of emitted light, which is a light beam from a light source.

The ¼ wavelength plate 6 is a phase contrast plate (optical element) for converting linearly polarized light into circularly polarized light and converting circularly polarized light into linearly polarized light. That is, the ¼ wavelength plate 6 converts a linearly polarized light beam having passed through the polarizing beam splitter 5 into a circularly polarized light beam and converts circularly polarized light reflected by the optical disc 8 into linearly polarized light. Consequently, emitted light incident to the polarizing beam splitter 5 has a polarization direction which is different by 90 degrees from that of reflected light incident to the polarizing beam splitter 5. That is, the polarization direction of the emitted light is perpendicular to the polarization direction of the reflected light.

The objective lens 7 is driven by an objective lens driving mechanism (not shown) in a focus direction (Z direction) and in a tracking direction (X direction). On this account, even if surface runout or eccentricity of the optical disc 8 occurs, a converged light spot keeps track of a predetermined position on a recording layer 8c.

The optical disc 8 includes: a substrate 8a; a cover layer 8b which transmits a light beam; and a recording layer 8c formed between the substrate 8a and the cover layer 8b.

The converging lens 9 converges a light beam reflected by the polarizing beam splitter 5.

The cylindrical lens 10 gives astigmatism to the light beam so that the photo detector 11 detects a focus error on the optical disc 8, and then causes the light beam to be incident to the photo detector 11.

The photo detector 11 converts the light beam into an electric signal so as to perform a focus control.

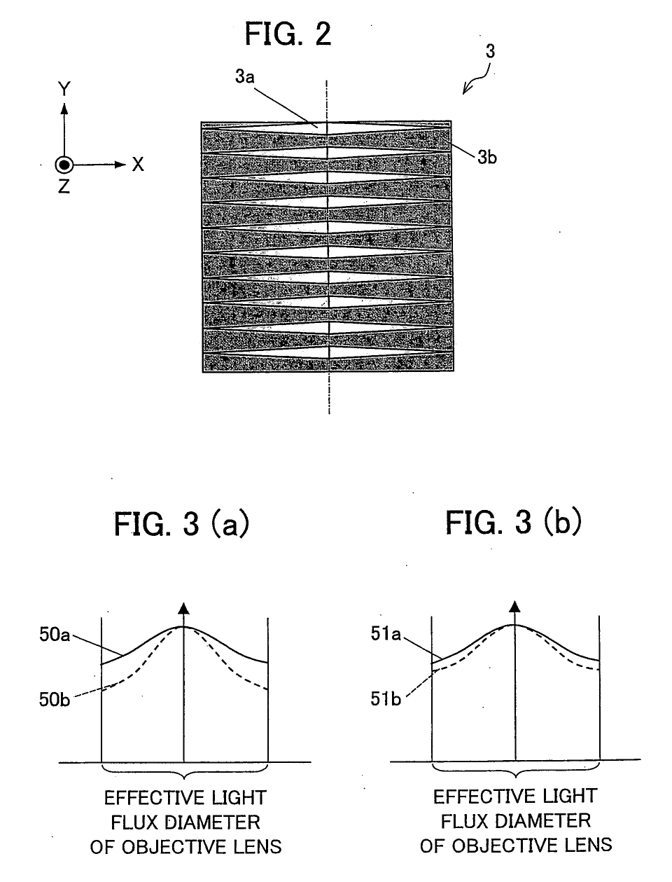

The diffraction grating 3 of the present embodiment includes a specific pattern for increasing RIM intensity of the objective lens 7, that is, for improving light intensity distribution of a light beam incident to the objective lens 7. The following explains a pattern of the diffraction grating 3 with reference to FIG. 2. FIG. 2 is an explanatory drawing for illustrating a pattern of the diffraction grating 3 used in the optical pickup device.

As illustrated in FIG. 2, the diffraction grating 3 of the present embodiment includes diffraction grooves made of mount portions 3a and valley portions 3b. The diffraction grating 3 is arranged so that a groove width varies from a central portion to a peripheral portion, that is, from a central portion in ± X directions. In other words, from the central portion to the peripheral portion in an X direction, the mount portions 3a gradually become small and the valley portions 3b gradually become large.

In the diffraction grating 3, by changing a ratio of the mount portions 3a to the valley portions 3b in the X direction, it is possible to control a diffraction efficiency ratio of a diffraction efficiency of zero order diffraction light to a diffraction efficiency of first order diffraction light. In other words, by adjusting a width of a diffraction groove formed in the diffraction grating 3, it is possible to control a diffraction efficiency ratio of a diffraction efficiency of zero order diffraction light to a diffraction efficiency of first order diffraction light. This allows light intensity distribution of a light beam emitted by the objective lens 7 to be less uneven and more uniform.

Note that, ± first order diffraction light, which is a sub beam for a tracking error signal, is generated in a Y direction of the diffraction grating 3.

Further, a pattern made of the mount portions 3a and the valley portions 3b of the diffraction grating 3 may be appropriately determined in line with a shape of the objective lens 7 and a diameter of a desired minute light spot formed on the optical disc 8.

The following explains how light intensity distribution depends on whether the diffraction grating 3 is provided or not.

FIG. 3(a) is an explanatory drawing for illustrating light intensity distribution in a case where the diffraction grating 3 is not provided in the optical pickup device. FIG. 3(b) is an explanatory drawing for illustrating light intensity distribution in a case where the diffraction grating 3 is provided in the optical pickup device. FIGS. 3(a) and 3(b) illustrate light intensity distributions within an effective light flux diameter of the object lens. Full lines 50a and 51a indicate light intensity in a direction parallel to a polarization direction of a light beam from the semiconductor laser 1. Broken lines 50b and 51b indicate light intensity in a direction perpendicular to the polarization direction of the light beam from the semiconductor laser 1.

The diffraction grating 3 of the present embodiment changes light intensity distribution in the direction parallel to the polarization direction of the light beam from the semiconductor laser 1. At that time, the polarization direction of the light beam from the semiconductor laser 1 is an X direction. Consequently, in the present embodiment, the full lines 50a and 51a are not influenced by the diffraction grating 3 in cases of FIGS. 3(a) and 3(b). Therefore, an influence of the diffraction grating 3 is explained with respect to the broken lines 50b and 51b.

In a case where the diffraction grating 3 is not provided, as shown by the broken line 50b in FIG. 3(a), light intensity distribution greatly changes between a central portion and a peripheral portion within an effective light flux diameter of the objective lens 7. That is, light intensity distribution of the objective lens 7 greatly changes, so that it is impossible to form a minute light spot on the optical disc 8.

On the other hand, in a case where the diffraction grating 3 is provided, as shown by the broken line 51b in FIG. 3(b), the change in light intensity distribution between the central portion and the peripheral portion within an effective light flux diameter of the objective lens 7 is small. In other words, RIM intensity of the objective lens 7 is improved. RIM intensity is defined as a ratio of intensity of a light flux incident to the center of the objective lens 7 to intensity of a light flux incident to the outermost part of the objective lens 7. That is, RIM intensity=(intensity of a light flux incident to the outermost part)/(intensity of a light flux incident to the central). Generally, RIM intensity is set as a standard with respect to each type of an optical recording medium or the like such as an optical disc 8.

For that reason, the diffraction grating 3 of the present embodiment is formed so that a ratio of the groove width changes between the central portion and the peripheral portion. Consequently, it is possible to increase first order diffraction efficiency at a central portion of the light beam and to drop first order diffraction efficiency between the central portion and the peripheral portion, so that it is possible to obtain uniform light intensity distribution of zero order diffraction light incident to the objective lens 7. Consequently, it is possible to form a minute light spot on the optical disc 8.

However, if a ratio of the mount portions 3a to the valley portions 3b is changed between the central portion and the peripheral portion as in a case of the diffraction grating 3 in FIG. 2, that is, if a width of a grating groove varies between the central portion and the peripheral portion, then astigmatism occurs in the diffraction grating 3.

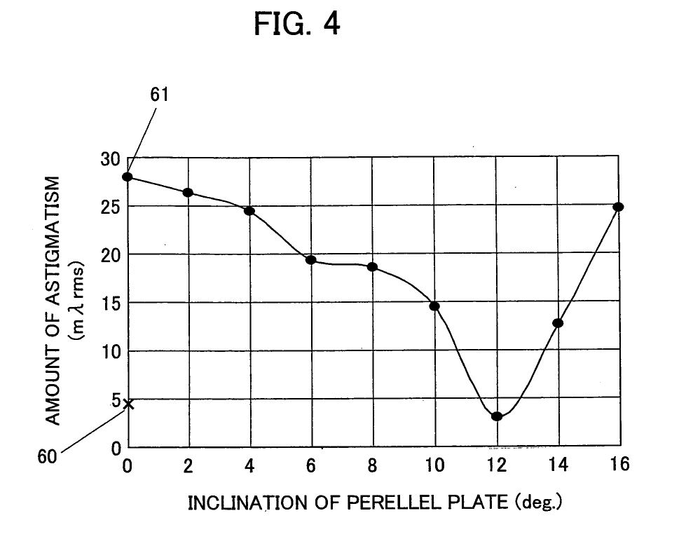

The following explains an influence of astigmatism and an influence of an inclination of the parallel plate 2 with respect to an optical axis in a case where the diffraction grating 3 is provided. FIG. 4 illustrates a result of measuring an amount of astigmatism of a light beam emitted by the semiconductor laser 1. A longitudinal axis indicates the amount of astigmatism (mλrms) and a transverse axis indicates an inclination of a parallel plate (deg.), which inclination is an angle between the parallel plate 2 and an optical axis of a light beam. If the inclination of the parallel plate 2 is 0 degree, the parallel plate 2 is perpendicular to the optical axis of the light beam. A X mark 60 indicates the amount of astigmatism generated in an optical system of an optical pickup device in a case where the diffraction grating 3 is not provided. A • mark 61 indicates the amount of astigmatism in a case where the diffraction grating 3 is provided. In the present embodiment, a thickness of the parallel plate 2 is 0.6 mm for example.

As is evident from the result of FIG. 4, the amount of astigmatism is higher in the case where the diffraction grating 3 is provided than in the case where the diffraction grating 3 is not provided. That is, it is obvious that providing the diffraction grating 3 generates astigmatism.

On the other hand, in the case where the diffraction grating 3 is provided, if the parallel plate 2 gets gradually inclined from a state in which the parallel plate 2 is perpendicular to an optical axis of a light beam, then the amount of astigmatism drops. When the parallel plate 2 is inclined to the optical axis at an angle of 12 degrees, the amount of generated astigmatism is substantially the same as the amount in the case where the parallel plate 2 is not provided. That is, by inclining the parallel plate 2 to the optical axis at an angle of 12 degrees, it is possible to cancel astigmatism due to the diffraction grating 3.

The above result is in a case where the thickness of the parallel plate 2 is 0.6 mm for example. In the same optical system, by selecting a thickness and an angle of the parallel plate 2, it is possible to use the most appropriate combination of the thickness and the angle. In other words, the thickness and the angle of the parallel plate 2 may be set with respect to an optical system of an optical pickup device so that astigmatism due to the diffraction grating 3 is reduced. With this, even if a pattern of the diffraction grating 3 is changed, it is possible to reduce astigmatism by selecting the thickness and the angle of the parallel plate 2.

As described above, the parallel plate 2 is provided so as to have a certain angle with respect to the optical axis and thus it is possible to reduce the amount of astigmatism due to a diffraction grating which changes light intensity distribution. Further, it is possible for an optical pickup device to form a minute light spot on the optical disc 8. Therefore, it is possible to prevent deterioration in quality of a reproduction signal and to prevent drop of amplitude of a tracking error signal, so that it is possible to perform a stable tracking control.

Further, in the present embodiment, the parallel plate 2 is provided between the semiconductor laser 1 and the collimator lens 4. Therefore, it is possible to give astigmatism for compensation to a light beam before the light beam is incident to the diffraction grating 3.

Further, in the present embodiment, the parallel plate 2 is formed so that an inclination of the parallel plate 2 can be adjusted. Consequently, in fabricating an optical pickup device, it is possible to appropriately adjust the inclination of the parallel plate 2 in line with astigmatism due to the diffraction grating 3. Consequently, it is easy to fabricate an optical pickup device. Thus, it is possible to increase efficiency in fabricating an optical pickup device.

Further, in the present embodiment, the parallel plate 2 is a light transmitting member having two parallel planes, so that it is unnecessary to perform positional adjustment of the parallel plate 2 in an optical axis direction and to perform rotational adjustment of the parallel plate 2 around the optical axis. That is, if the inclination of the parallel plate 2 is adjusted with respect to one axis of the optical axis, then it is possible to generate desired astigmatism. Therefore, it is possible to fabricate an optical pickup device with an easier process than a conventional case.

### Embodiment 2

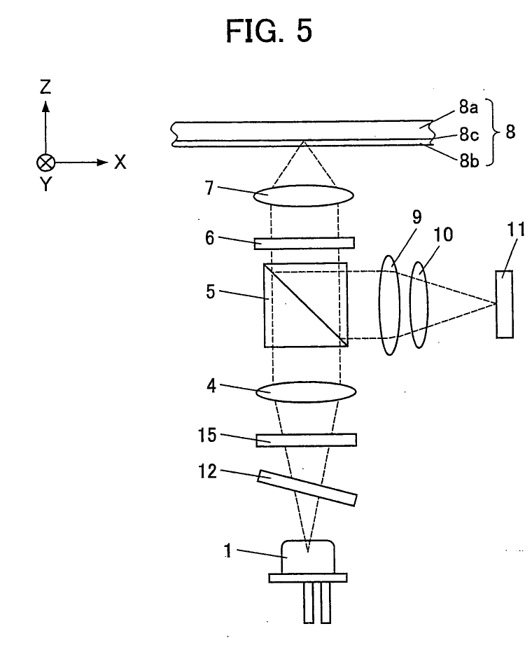

The following explains another embodiment of the present invention with reference to FIGS. 5 to 7. Note that, the present embodiment has the same arrangements as those of Embodiment 1 except for arrangements which will be explained below. Further, for convenience of explanation, elements having the same functions as those of the elements illustrated in drawings of Embodiment 1 are given the same signs and explanations thereof will be omitted below.

FIG. 5 is a cross sectional drawing for illustrating an optical pickup device of the present embodiment. As illustrated in FIG. 5, the optical pickup device of the present embodiment is arranged so that the semiconductor laser 1 is provided so as to be turned by 90 degrees on a plane perpendicular to the optical axis in the arrangement of the optical pickup device of Embodiment 1. That is, the semiconductor laser 1 in FIG. 1 is turned by 90 degrees from an X direction to a Y direction. Further, the present embodiment is different from Embodiment 1 in terms of a pattern of a diffraction grating, and is different from Embodiment 1 in that the present embodiment uses a ½ wavelength plate instead of the parallel plate 2 so as to improve astigmatism due to the diffraction grating.

First, with reference to FIG. 5, the following explains a light path of a light beam emitted by the semiconductor laser 1 of the optical pickup device of the present embodiment. For convenience of explanation, FIG. 5 illustrates only a periphery of a light beam by use of broken lines.

As described above, the semiconductor laser 1 is provided so as to be turned by 90 degrees with respect to that of Embodiment 1. Consequently, a light beam emitted by the semiconductor laser 1 has a polarization direction which allows the polarizing beam splitter 5 to reflect the light beam. That is, if the light beam is incident to the polarizing beam splitter 5, then the light beam is reflected by the polarizing beam splitter 5.

For that reason, the optical pickup device of the present embodiment includes a ½ wavelength plate 12 instead of the parallel plate 2. The ½ wavelength plate 12 is a phase contrast plate which changes a polarization direction of a light beam by 90 degrees.

Here, a light path is explained as follows. A light beam which is light emitted by the semiconductor laser 1 is incident to the ½ wavelength plate 12. Consequently, a polarization direction of a light beam 35 is turned by 90 degrees. Then, the light beam 35 having passed through the ½ wavelength plate 12 is incident to a diffraction grating 15.

The diffraction grating 15 has grating grooves with a predetermined pattern, that is, with a predetermined groove width so as to correct light intensity distribution in a tangential direction (Tan direction) on the optical disc 8.

Next, the light beam is compensated by the diffraction grating 15 so as to have desired light intensity distribution and then is incident to the polarizing beam splitter 5. The light beam has turned its polarization direction by 90 degrees, so that the light beam passes through the polarizing beam splitter 5 and is incident to the ¼ wavelength plate 6. Then, the light beam is incident to an optical disc 8 through the ¼ wavelength plate 6 and an objective lens 7. A reflected light reflected by the optical disc 8 is incident to the polarizing beam splitter 5 through the objective lens 7 and the ¼ wavelength plate 6, and is reflected by the polarizing beam splitter 5, and is received by a photo detector 11 through a converging lens 9 and a cylindrical lens 10.

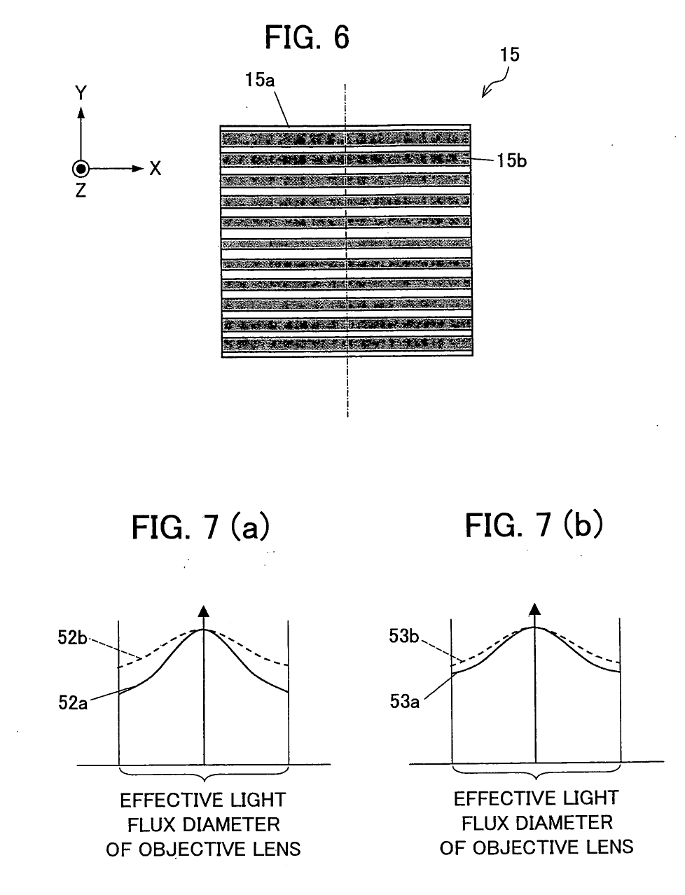

Next, the following details the diffraction grating 15 of the present embodiment with reference to FIG. 6. FIG. 6 is an explanatory drawing for illustrating a pattern of a diffraction grating used in the optical pickup device.

As described above, the diffraction grating 15 is a diffraction element for compensating light intensity distribution in a tangential direction (Tan direction) on the optical disc 8. Here, the tangential direction indicates a direction which is along a track groove of an optical disc. As illustrated in FIG. 6, the diffraction grating 15 includes mount portions 15a and valley portions 15b. The mount portions 15a and the valley portions 15b are formed alternately so that a predetermined groove width is provided in a Y direction. To be more specific, in a central portion of the diffraction grating 15, a width of a mount portion 15a gets small and a width of a valley portion 15b gets large. On the other hand, from the central portion to a peripheral portion of the diffraction grating 15, the width of the mount portion 15a gradually gets large and the width of the valley portion 15b gradually gets small. In other words, a ratio of the mount portion 15a to the valley portion 15b changes in the Y direction.

Consequently, it is possible to control a ratio of zero order diffraction efficiency to a first order diffraction efficiency in the Y direction. Therefore, it is possible to correct light intensity distribution in the Tan direction on the optical disc 8. Note that, in the diffraction grating 15, ± first order diffraction light which is a sub beam for a tracking error signal is generated in the Y direction.

A pattern made of the mount portions 15a and the valley portions 15b of the diffraction grating 15 may be appropriately determined in line with a shape of the objective lens 7 and a diameter of a desired minute light spot formed on the optical disc 8.

Further, in other words, the diffraction grating 15 of the present embodiment is arranged so that light intensity distribution in a direction perpendicular to a polarization direction of a light beam from the semiconductor laser 1 is changed. That is, as with the broken line 51b in FIG. 3(b) in Embodiment 1, it is preferable that a change in light intensity distribution is small from a central portion to a peripheral portion within an effective light flux diameter of the objective lens 7. Therefore, in the diffraction grating 15 of the present embodiment, a ratio of a groove width is changed between a central portion and a peripheral portion, so that first order diffraction efficiency is increased at a central portion of a light beam and first order diffraction efficiency drops at a peripheral portion of the light beam. Consequently, light intensity distribution of zero order diffraction light incident to the objective lens is changed.

The following explains how light intensity distribution depends on whether the diffraction grating 15 is provided or not.

FIG. 7(a) is an explanatory drawing for illustrating light intensity distribution in a case where a diffraction grating is not provided in the optical pickup device. FIG. 7(b) is an explanatory drawing for illustrating light intensity distribution in a case where a diffraction grating is provided in the optical pickup device. Full lines 52a and 53a in FIGS. 7(a) and 7(b) indicate light intensity in a direction perpendicular to a polarization direction of a light beam from the semiconductor laser 1. Broken lines 52b and 53b indicate light intensity in a direction parallel to the polarization direction of the light beam from the semiconductor laser 1.

As is evident from the broken lines 52a and 53a in FIGS. 7(a) and 7(b), by providing the diffraction grating 15, a change in light intensity distribution between the central portion and the peripheral portion within the effective light flux diameter of the objective lens 7 becomes small. That is, it is obvious that RIM intensity is improved.

Consequently, light intensity distribution in the Tan direction of the optical disc 8 is compensated, so that it is possible to form a minute light spot on the optical disc 8.

However, although providing the diffraction grating 15 allows for reduction of a change in light intensity distribution, providing the diffraction grating 15 also generates astigmatism as with the case of the diffraction grating 3 of Embodiment 1.

In the present embodiment, in order to reduce astigmatism due to the diffraction grating 15, the ½ wavelength plate 12 is provided, instead of the parallel plate 2, between the semiconductor laser 1 and the polarizing beam splitter 5 so as to be inclined to an optical axis of the semiconductor laser 1. To be more specific, the ½ wavelength plate 12 is provided between the semiconductor laser 1 and the diffraction grating 15 so as to be inclined to the optical axis of the semiconductor laser 1. Therefore, the ½ wavelength plate 12 is provided so as to be inclined to the optical axis at a predetermined angle.

As described above, in the present embodiment, the ½ wavelength plate 12 is provided so as to be inclined to the optical axis, so that substantially the same effect as the effect brought by the parallel plate 2 in Embodiment 1 can be obtained. That is, it is possible to reduce astigmatism due to the diffraction grating 15. In this case, it is unnecessary to separately provide the parallel plate 2, so that it is possible to prevent an increase in fabrication costs. Further, additional fabrication processes are not necessary, so that fabrication efficiency is high.

### Embodiment 3

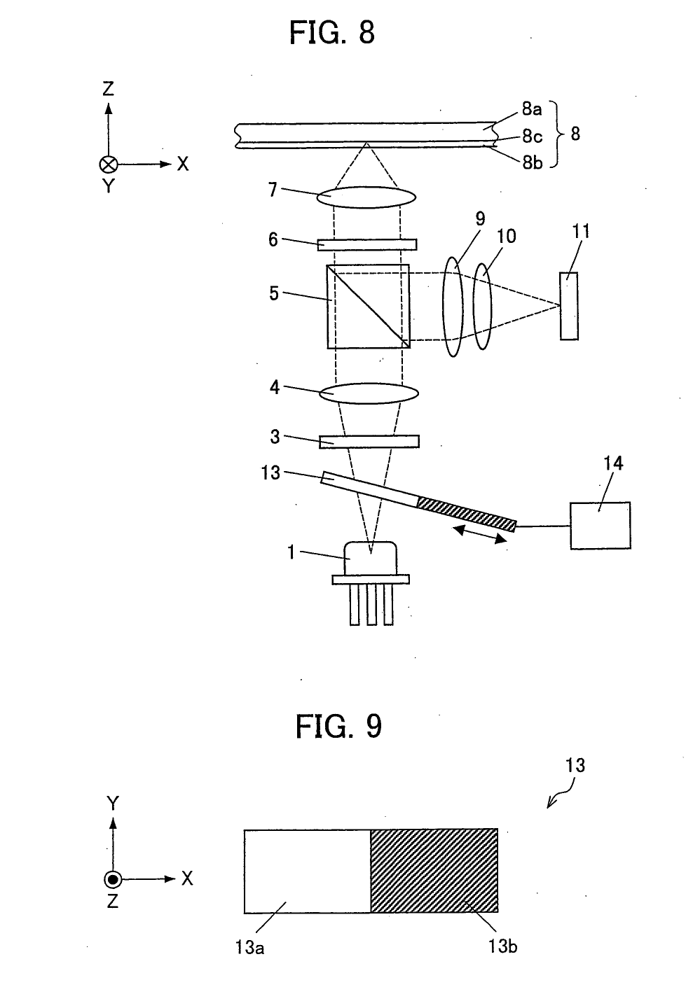

The following explains further another embodiment of the present invention with reference to FIGS. 8 and 9. Note that, the present embodiment has the same arrangements as those of Embodiments 1 and 2 except for arrangements which will be explained below. Further, for convenience of explanation, elements having the same functions as those of the elements illustrated in drawings of Embodiments 1 and 2 are given the same signs and explanations thereof will be omitted below.

FIG. 8 is a cross sectional drawing of an optical pickup device of the present embodiment. As illustrated in FIG. 8, the optical pickup device of the present embodiment is arranged so that, in addition to the arrangement of the optical pickup device of Embodiment 1, an optical element 13 which includes areas having different light transmittances is provided, instead of a parallel plate, between the semiconductor laser 1 and the diffraction grating 3 so as to be inclined to an optical axis.

Further, the optical pickup device of the present embodiment includes a switching device (switching means) 14. The switching device 14 moves the optical element 13 in parallel to a direction in which the optical element 13 is inclined. The switching device 14 is not particularly limited as long as it changes a position of the optical element 13 to which position a light beam is incident.

FIG. 9 is a cross sectional drawing for illustrating a structure of the optical element 13 in the optical pickup device. As illustrated in FIG. 9, the optical element 13 includes two areas having different light transmittances, that is, a first area 13a and a second area 13b. The first area 13a transmits, for example, substantially 100% of wavelength area of light emitted by the semiconductor laser 1. The second area 13b transmits, for example, substantially 50% of wavelength area of light emitted by the semiconductor laser 1. The first area 13a and the second area 13b may be appropriately set to have desired light transmittances. At that time, the first area 13a and the second area 13b in the optical element 13 have a certain angle between each of the first and second areas 13a and 13b and an optical axis.

The following explains what influence the shape of the optical disc 8 has on an optical pickup device.

For example, if a recording layer 8c of the optical disc 8 includes a plurality of recording layers, then a larger amount of light from the objective lens 7 is necessary than a case where the optical disc 8 includes only one recording layer. For that reason, it is general in an optical system of an optical pickup device that specs of optical elements such as a collimator lens 4 are determined based on a radiation angle or a necessary light power of the semiconductor laser 1.

However, an output of the semiconductor laser 1 has an upper limit. On the other hand, in a low-output range of the semiconductor laser 1, laser noise tends to increase. Therefore, an output of the semiconductor laser 1 in usage is often arranged so as to have a lower limit for reducing the laser noise.

For that reason, it is necessary to design the optical system of the optical pickup device so that, in recording/reading information to/from the optical disc 8 including a plurality of recording layers 8, light usage efficiency does not drop as much as possible. On the other hand, it is necessary to design the optical system of the optical pickup device so that, in recording/reading information to/from the optical disc 8 including a single recording layer 8, an output of the semiconductor laser 1 is increased for reducing an influence of laser noise and light usage efficiency corresponding to an increased output drops.

In the present embodiment, the optical element 13 is movable in parallel to a direction in which the optical element 13 is inclined to the optical axis. Consequently, it is possible to provide areas having different patterns for an effective light flux area of a light beam in line with the type of the optical disc 8. That is, it is possible to cause light to be incident to an area having a desired pattern. Therefore, in recording/reading information to/from the optical disc 8 including the plurality of recording layers 8c, by providing the first area 13a of the optical element 13 for the optical axis, it is possible to record/reproduce information to/from the optical disc 8 without dropping light usage efficiency.

On the other hand, in the case of the optical disc 8 including the single recording layer 8c, by providing the second area 13b of the optical element 13 for the optical axis, it is possible to record/reproduce information to/from the optical disc 8 while reducing laser noise due to an output of the semiconductor laser 1 and reducing light transmittance, that is, light usage efficiency. In other words, it is possible to emit an appropriate amount of light onto the optical disc 8. Consequently, it is possible to detect an information signal such as a tracking error signal with higher accuracy, so that it is possible to record/reproduce information to/from the optical disc 8 with higher accuracy.

The optical pickup device of the present embodiment includes a diffraction grating 3 for compensating light intensity distribution of light from the semiconductor laser 1. Consequently, the diffraction grating 3 generates astigmatism.

In the present embodiment, in order to reduce the astigmatism, as described above, the optical element 13 is provided so as to be inclined to the optical axis. Consequently, astigmatism due to the diffraction grating 3 can be reduced. Therefore, in an optical pickup device used for an optical disc including more than two layers, too, it is possible to reduce astigmatism, so that it is possible to prevent deterioration in quality of a reproduction signal.

Note that, in the present embodiment, the optical element 13 includes the first area 13a and the second area 13b having different light transmittances. However, the optical element 13 may further include more than two areas having different light transmittances.

### Embodiment 4

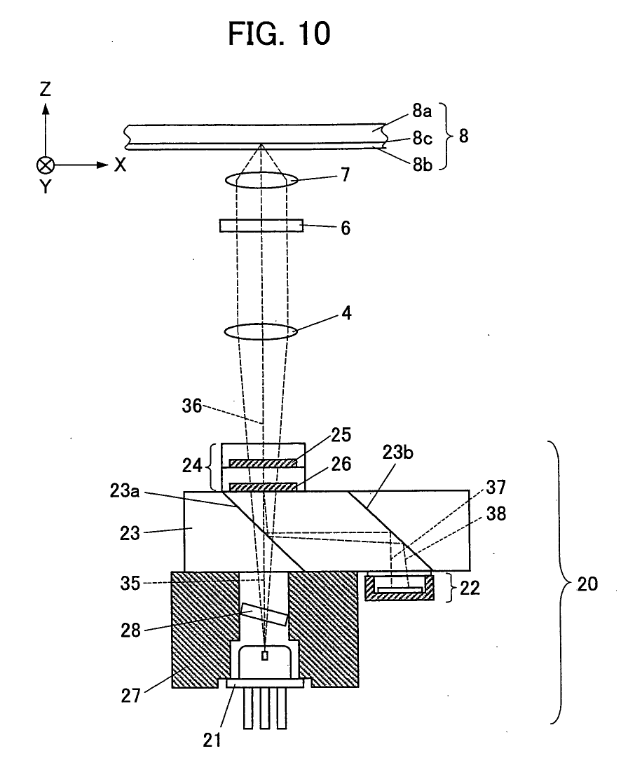

The following explains further another embodiment of the present invention with reference to FIG. 10. Note that, the present embodiment has the same arrangements as those of Embodiments 1 to 3 except for arrangements which will be explained below. Further, for convenience of explanation, elements having the same functions as those of the elements illustrated in drawings of Embodiments 1 to 3 are given the same signs and explanations thereof will be omitted below.

FIG. 10 is a cross sectional drawing of an optical pickup device of the present embodiment. As illustrated in FIG. 10, the optical pickup device of the present embodiment includes an integrated optical unit 20 in which a semiconductor laser 21 and a photo detector 22 are integrally provided.

With reference to FIG. 10, the following explains an arrangement of each section of the optical pickup device and a light path of the optical pickup device. For convenience of explanation, FIG. 10 illustrates a periphery and an optical axis of a light beam by use of broken lines.

The optical pickup device of the present embodiment includes the integrated optical unit 20, a collimator lens 4, a ¼ wavelength plate 6, and an objective lens 7.

A light beam 35 emitted by the semiconductor laser 21 mounted on the integrated optical unit 20 is changed by the collimator lens 4 to be collimated light, which converges on the optical disc 8 through the ¼ wavelength plate 6 and the objective lens 7. A light beam 36 which is reflected light from the optical disc 8 passes through the objective lens 7 and the collimator lens 4, and converges on the photo detector 22 mounted on the integrated optical unit 20.

Here, the integrated optical unit 20 includes the semiconductor laser 21, the photo detector 22, a polarizing beam splitter 23, a first polarization diffraction element 24, a support member 27, and a parallel plate 28.

The light beam (emitted light) 35 is emitted as linearly P-polarized light by the semiconductor laser 1 supported by the support member 27, and passes through the parallel plate 28 and a polarizing beam splitter (PBS) plane 23a of the polarizing beam splitter 23, and is incident to the first polarization diffraction element 24.

Here, the first polarization diffraction element 24 includes: a first polarization hologram element 25 for diffracting P-polarized light and transmitting S-polarized light; and a second polarization hologram element 26 for diffracting S-polarized light and transmitting P-polarized light.

Therefore, the light beam 35 with P-polarization, which has passed through the PBS plane 23a, passes through the second polarization hologram element 26 and is diffracted by the first polarization hologram element 25.

Next, the light beam 35 emitted by the first polarization hologram element 25 is incident to the collimator lens 4 so as to be collimated light, which is converted by the ¼ wavelength plate 6 from linearly P-polarized light to circularly polarized light. Then, the light beam with circular polarization is converged by the objective lens 7 onto the optical disc 8.

The light beam (reflected light) 36 reflected by the optical disc 8 is converted by the ¼ wavelength plate 6 from circularly polarized light to linearly S-polarized light. That is, the light beam 35 which is emitted light and the light beam 36 which is reflected light are linearly polarized light whose polarization directions are perpendicular to each other. Therefore, the light beam 36 which is reflected light passes through the first polarization hologram element 25 and is diffracted by the second polarization hologram element 26. The light beam 36 is reflected by the PBS plane 23a and a reflecting mirror plane 23b of the polarizing beam splitter 23 so as to be separated into a zero order diffraction light (non-diffraction light) 37 and a first order diffraction light (diffraction light) 38, which are incident to the photo detector 22. Note that, the PBS plane 23a and the reflecting mirror plane 23b of the polarizing beam splitter 23 constitute two parallel planes.

The first polarization hologram element 25 not only includes a pattern for diffracting P-polarized light and transmitting S-polarized light, but also includes a pattern for generating three beams used to correct light intensity distribution of light emitted by the semiconductor laser 21 and to detect a tracking error signal (TES), that is, a pattern for generating zero order diffraction light and ± first order diffraction light. That is, the first polarization hologram element 25 includes the same pattern as that of the diffraction grating 3 in FIG. 3. Consequently, as with the diffraction grating 3 in Embodiment 1, in the first polarization diffraction element 24 in the present embodiment, astigmatism is generated.

However, in the present embodiment, the parallel plate 28 is provided between the semiconductor laser 21 and the first polarization diffraction element 24 so as to be inclined to an optical axis. Consequently, the parallel plate 28 is inclined to the optical axis at an angle allowing for compensation of astigmatism due to the first polarization diffraction element 24. Therefore, the light beam 35 emitted by the semiconductor laser 21 is given predetermined astigmatism by the parallel plate 28. Consequently, when the light beam 35 is incident to the first polarization diffraction element 24, it is possible to reduce astigmatism due to the first polarization diffraction element 24. Therefore, it is possible to reduce astigmatism in an optical system using the first polarization diffraction element 24, so that it is possible to form a minute light spot on the optical disc 8 and to obtain a reproduction signal without any deterioration.

Further, in the present embodiment, the polarizing beam splitter 23 is provided between the semiconductor laser 1 and the collimator lens 4, so that it is possible to shorten a distance between the collimator lens 4 and the objective lens 7. Consequently, it is possible to downsize an optical pickup device.

### Embodiment 5

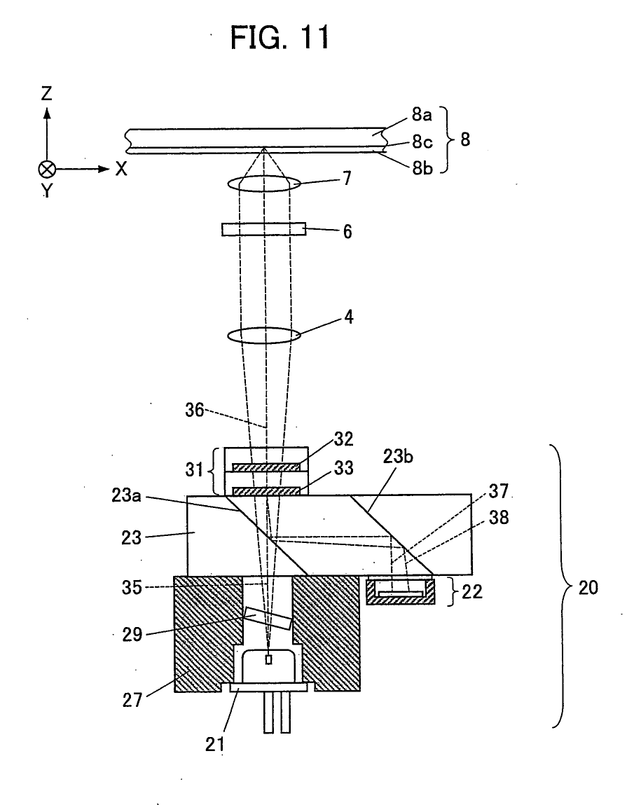

The following explains further another embodiment of the present invention with reference to FIG. 11. Note that, the present embodiment has the same arrangements as those of Embodiments 1 to 4 except for arrangements which will be explained below. Further, for convenience of explanation, elements having the same functions as those of the elements illustrated in drawings of Embodiments 1 to 4 are given the same signs and explanations thereof will be omitted below.

FIG. 11 is a cross sectional drawing of an optical pickup device of the present embodiment. As illustrated in FIG. 11, the optical pickup device of the present embodiment is arranged so that a semiconductor laser 21 is provided so as to be turned by 90 degrees. Consequently, a light beam 35 has a polarization direction which allows a PBS plane 23a of a polarizing beam splitter 23 to reflect the light beam 35.

For that reason, instead of the parallel plate 28 in Embodiment 4, a ½ wavelength plate 29 is provided between the semiconductor laser 21 and the polarizing beam splitter 23. Consequently, the light beam 35 passes through the polarizing beam splitter 23 without being reflected by the PBS plane 23a.

A first polarization diffraction element 31 includes: a first polarization hologram element 32 for diffracting P-polarized light and transmitting S-polarized light; and a second polarization hologram element 33 for diffracting S-polarized light and transmitting P-polarized light. Consequently, in the polarizing beam splitter 23, the light beam 35 which is emitted light and a light beam 36 which is reflected light have polarization directions perpendicular to each other.

Here, the first polarization hologram element 32 not only includes a pattern for diffracting P-polarized light and transmitting S-polarized light, but also includes a pattern for compensating light intensity distribution in a Tan direction on an optical disc 8. That is, the first polarization hologram element 32 not only includes a pattern for diffracting P-polarized light and transmitting S-polarized light, but also includes the same pattern as that of the diffraction grating 15 in FIG. 6 of Embodiment 2. Therefore, astigmatism is generated by the first polarization diffraction element 31 which includes the first polarization hologram element 32.

However, in the present embodiment, the ½ wavelength plate 29 is provided so as to be inclined to an optical axis of the light beam 35, so that it is possible to generate new astigmatism for compensating the astigmatism due to the first polarization diffraction element 31. Consequently, it is possible to improve light intensity distribution of an objective lens 7 in a Tan direction of the optical disc 8. Further, it is unnecessary to separately provide a parallel plate, so that it is possible to reduce fabrication costs.

### Embodiment 6

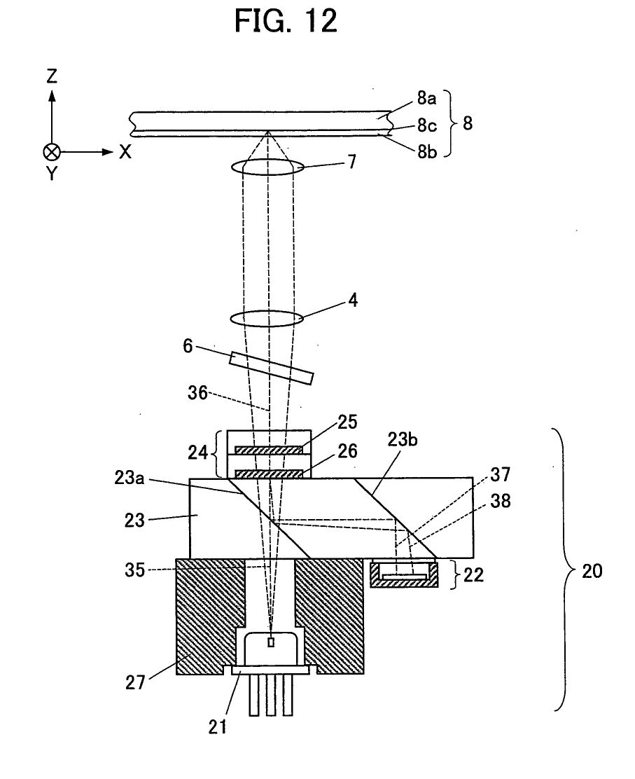

The following explains further another embodiment of the present invention with reference to FIG. 12. Note that, the present embodiment has the same arrangements as those of Embodiments 1 to 5 except for arrangements which will be explained below. Further, for convenience of explanation, elements having the same functions as those of the elements illustrated in drawings of Embodiments 1 to 5 are given the same signs and explanations thereof will be omitted below.

FIG. 12 is a cross sectional drawing of an optical pickup device of the present embodiment. As illustrated in FIG. 12, the optical pickup device of the present embodiment includes the arrangement of Embodiment 4 and is arranged so that a parallel plate 28 is not provided between a semiconductor laser 21 and a polarizing beam splitter 23 and a ¼ wavelength plate 6 is provided between a first polarization diffraction element 24 and a collimator lens 4 so as to be inclined to an optical axis.

With the arrangement, the ¼ wavelength plate 6 is used as a light transmitting member for compensating astigmatism, so that it is possible to reduce astigmatism due to the first polarization diffraction element 24 without providing additional elements. Consequently, it is possible to obtain a reproduction signal in a good condition.

Further, in the present embodiment, the ¼ wavelength plate 6 is provided between the polarizing beam splitter 23 and the objective lens 7, to be more specific, between the first polarization diffraction element 24 and the collimator lens 4, so that it is possible to astigmatize a light beam 35 before the light beam 35 is changed by the collimator lens 4 to collimated light. Consequently, the collimated light is incident to the objective lens 7, so that it is possible to prevent unevenness of light intensity distribution.

A ¼ wavelength plate is an optical element for changing linearly polarized light to circularly polarized light and for changing circularly polarized light to linearly polarized light. In the present embodiment, the ¼ wavelength plate 6 changes P-polarized light having passed through light splitting means to circularly polarized light and changes the circularly polarized light reflected by the optical disc 8 to S-polarized light, so that the S-polarized light is incident to the polarizing beam splitter 23 and is reflected by the polarizing beam splitter 23. In order that the ¼ wavelength plate 6 serves as described above, the ¼ wavelength plate 6 should be provided between the polarizing beam splitter 23 and the optical disc 8. Further, if the ¼ wavelength plate 6 is positioned at a collimated light flux, inclining the ¼ wavelength plate 6 only changes a light path (optical axis). Therefore, in order to cancel astigmatism, the ¼ wavelength plate 6 should be positioned at a converging light flux. For the above two reasons, it is preferable that the ¼ wavelength plate is provided between the polarizing beam splitter 23 and the collimator lens 4.

### Embodiment 7

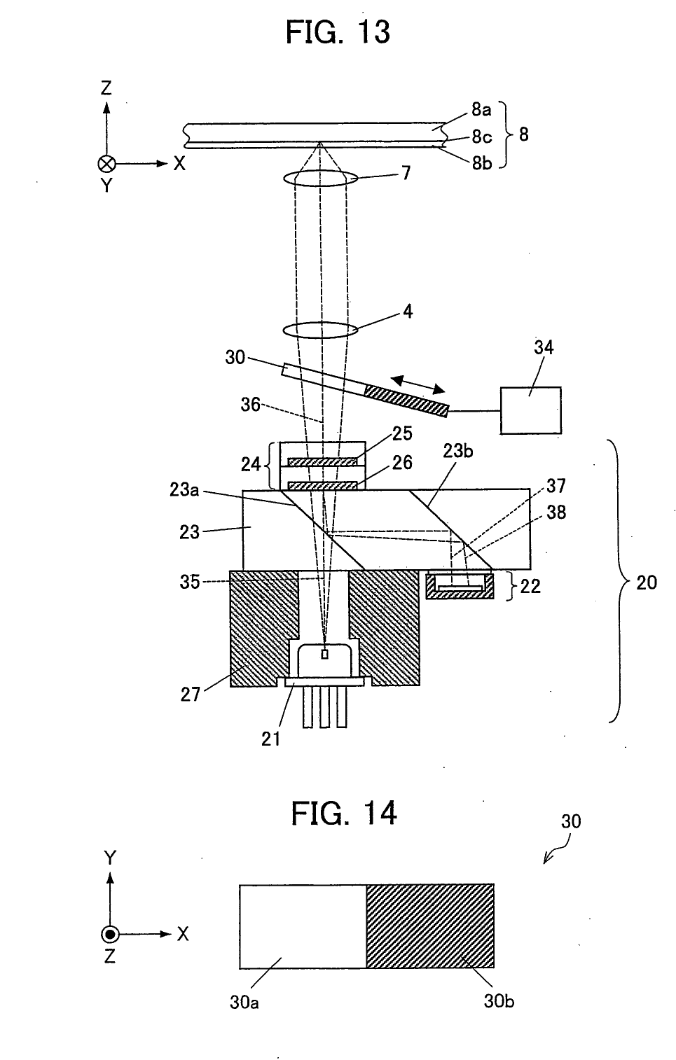

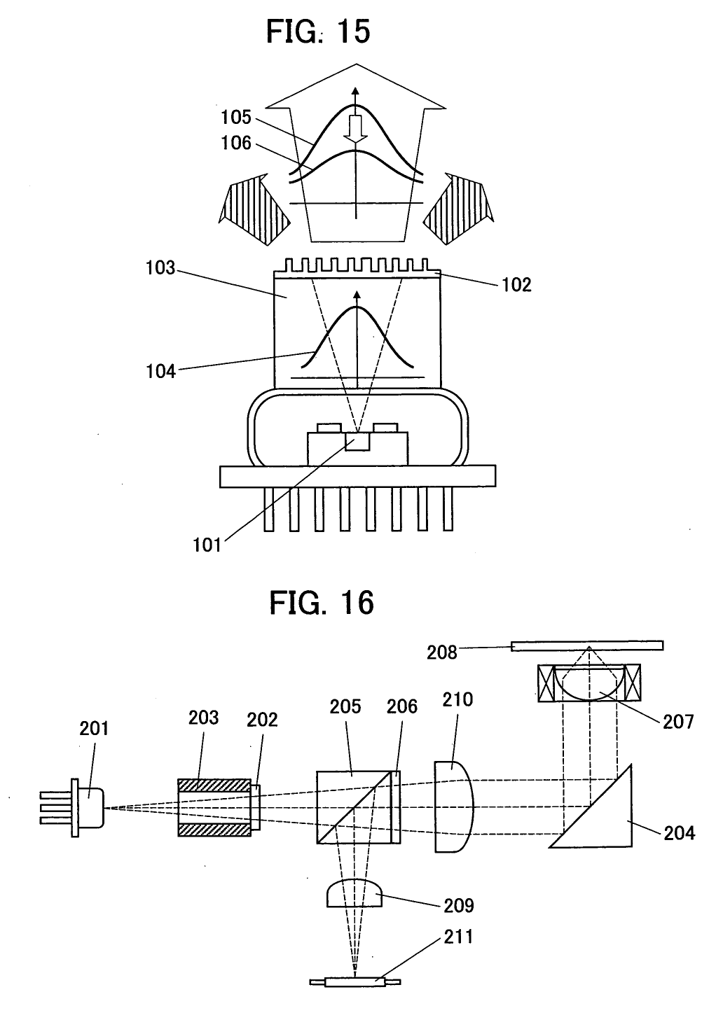

The following explains further another embodiment of the present invention with reference to FIGS. 13 and 14. Note that, the present embodiment has the same arrangements as those of Embodiments 1 to 6 except for arrangements which will be explained below. Further, for convenience of explanation, elements having the same functions as those of the elements illustrated in drawings of Embodiments 1 to 6 are given the same signs and explanations thereof will be omitted below.

FIG. 13 is a cross sectional drawing of an optical pickup device of the present embodiment. As illustrated in FIG. 13, the optical pickup device of the present embodiment is arranged so as to include the arrangement of Embodiment 6 and is arranged so that, instead of the ¼ wavelength plate 6, a second polarization diffraction element 30 is provided between an integrated optical unit 20 and a collimator lens 4 so as to be inclined to an optical axis.

Further, the optical pickup device of the present embodiment includes a switching device (switching means) 34. The switching device 34 moves the second polarization diffraction element 30 in parallel to a direction in which the second polarization diffraction element 30 is inclined. Note that, the switching device 34 is not particularly limited as long as it changes a position of the second polarization diffraction element 30 to which position a light beam is incident.

FIG. 14 is a cross sectional drawing for illustrating a structure of the second polarization diffraction element 30 of the optical pickup device. As illustrated in FIG. 14, the second polarization diffraction element 30 includes a first area 30a and a second area 30b. The first area 30a does not have grating grooves formed therein. The second area 30b have grating grooves with 50% of a duty ratio formed in a Y direction in FIG. 14. Here, “duty ratio” indicates a ratio of a groove width to a grating groove period.

The first area 30a transmits a light beam 35 which is light emitted by the semiconductor laser 21 and a light beam 36 which is light reflected by the optical disc 8, regardless of polarization directions of the light beams 35 and 36.

On the other hand, in the second area 30b, a grating groove interval is set so that zero order diffraction light and ± first order diffraction light are generated in a polarization direction of light emitted by the semiconductor laser 1 and only the zero order diffraction light is incident to an objective lens 7. New ± first order diffraction light are not generated in a polarization direction of the light beam 36 from the optical disc 8, and the light beam 36 passes through the second area 30b and is incident to the integrated optical unit 20.

Note that, in either area, a diffraction direction of a light beam is perpendicular to a direction of a light beam used to generate a tracking error signal.

As described above, in the present embodiment, areas having different duty ratios are provided, so that ± first diffraction light not used for recording/reading a signal is generated. Therefore, by adjusting an amount of the ± first diffraction light (by adjusting a groove depth), it is possible to control light transmittance.

For example, by designing the second area 30b so that + first order diffraction light: zero order diffraction light: − first order diffraction light is 1:2:1, it is possible to make a 50% reduction of light used to record/reproduce a signal.

Further, in the present embodiment, the second polarization diffraction element 30 is movable in parallel to a direction in which the second polarization diffraction element 30 is inclined to an optical axis, so that it is possible to provide an area having a desired duty ratio for an effective light flux diameter of the light beam 35. Consequently, it is possible to cause areas having different light transmittances to transmit a light beam in line with recording layers of an optical recording medium, so that it is possible to emit a light beam with an appropriate amount to the optical recording medium without increasing laser noise.

Further, the second polarization diffraction element 30 is provided so as to be inclined to an optical axis, so that it is possible to reduce astigmatism due to the first polarization diffraction element 24. Consequently, it is possible to obtain a signal in a better condition without deterioration in quality of a reproduction signal from the optical disc 8 including a single recoding layer or plurality of recording layers.

Note that, in the present embodiment, the second polarization diffraction element 30 includes two areas having different duty ratios. However, the second polarization diffraction element 30 may include more than two areas having different duty ratios in line with a polarization direction of a light beam.

The present invention is not limited to the above embodiments, and a variety of modifications are possible within the scope of the following claims, and embodiments obtained by combining technical means respectively disclosed in the above embodiments are also within the technical scope of the present invention.

As described above, an optical pickup device of the present invention further includes a light transmitting member for compensating astigmatism due to the diffraction element, the light transmitting member being provided between the light source and the collimator lens so as to be inclined to an optical axis of the light source.

Consequently, it is possible to generate new astigmatism for compensating the astigmatism due to the diffraction element. Therefore, it is possible to cancel the astigmatism due to the diffraction element by using the new astigmatism generated by the light transmitting member. Consequently, it is possible to reduce an influence of the astigmatism due to the diffraction element. Therefore, it is possible to converge the light beam on an optical recoding medium as a minute light spot, so that it is possible to prevent deterioration in quality of a reproduction signal recorded in the optical recording medium or to prevent drop of an amplitude of a tracking error signal.

Further, the light transmitting member is inclined so as to generate predetermined astigmatism, so that it is possible to fabricate an optical pickup deice with a simpler process than a conventional process in which a light transmitting member is subjected to positional adjustment in an optical axis direction and to rotational adjustment around the optical axis, that is, the light transmitting member is adjusted with respect to two axes.

Consequently, it is possible to reduce astigmatism due to the diffraction grating capable of compensating light intensity distribution of a light beam emitted by a light source and to provide an optical pickup device allowing for a simpler fabrication process.

It is preferable to arrange the optical pickup device of the present invention so that an angle of inclination of the light transmitting member is adjustable.

With the arrangement, the angle of inclination of the light transmitting member is adjustable, so that it is possible to appropriately adjust the angle of inclination of the light transmitting member in a fabrication process of an optical pickup device in line with astigmatism due to the diffraction element. Consequently, it is possible to fabricate an optical pickup device with ease. Therefore, it is possible to increase fabrication efficiency.

It is preferable to arrange the optical pickup device of the present invention so that the light transmitting member is a parallel plate.

With the arrangement, the light transmitting member is a parallel plate. Consequently, positional adjustment in an optical axis direction and rotational adjustment around the optical axis, each performed in a conventional technique, are unnecessary, and by adjusting an inclination of the light transmitting member with respect to a single optical axis, it is possible to generate astigmatism for compensation.

It is preferable to arrange the optical pickup device of the present invention so that the light transmitting member is a ½ wavelength plate for shifting a phase of an incident light beam by ½ wavelength.

In a case where a polarization direction of a light beam from a light source is different from a desired polarization direction by 90 degrees for example, by providing a ½ wavelength plate in an optical pickup device, it is possible to turn the polarization direction of the light beam by 90 degrees. In other words, the ½ wavelength plate is used in line with characteristics of light splitting means which includes a polarizing beam splitter. The ½ wavelength plate is a phase contrast plate which shifts a phase of an incident light beam by ½ wavelength so as to turn a polarization plane of linearly polarized light or circularly polarized light by 90 degrees.

With the arrangement, the light transmitting member is a ½ wavelength plate which shifts the phase of an incident light beam by ½ wavelength. Consequently, if the ½ wavelength plate is provided in the optical pickup device beforehand, it is possible to reduce an influence of astigmatism due to a diffraction element without providing new elements.

It is preferable to arrange the optical pickup device of the present invention so that the light transmitting member includes at least two areas having different light transmittances.

For example, in a case of an optical recording medium including a plurality of recording layers, it is necessary to irradiate a large amount of light to the optical recording medium. On the other hand, in a case of an optical recording medium including a single recording layer, it is necessary to irradiate a small amount of light to the optical recording medium. At that time, if a light source made of a semiconductor laser for example emits a low output of light for irradiating a small amount of light, then there is a possibility that laser noise increases in an optical system. For example, if laser noise increases, it is impossible to exactly record/reproduce information to/from the optical recording medium.

With the arrangement of the present invention, the light transmitting member includes at least two areas having different light transmittances. For example, in a case where a light source emits a light beam with such an output that laser noise does not increases, if the light beam is incident to an area having high light transmittance of the light transmitting member, then it is possible to emit a light beam having substantially the same amount as that of a light beam incident to the area having high light transmittance. On the other hand, if the light beam is incident to an area having low light transmittance, then it is possible to emit a light beam having an amount less than that of the light beam incident to the area having low light transmittance.

Consequently, in the case of the optical recording medium including a plurality of recording layers, the area with high light transmittance transmits a light beam with a high output from a light source, so that it is possible to irradiate the light beam with a high output to the optical recording medium. On the other hand, in the case of the optical recording medium including a single recording layer, if the area with low light transmittance transmits a light beam with such an output that laser noise does not increase, then it is possible to reduce an amount of the light beam, so that it is possible to irradiate a small amount of a light beam to the optical recording medium. Therefore, by causing areas having different light transmittances to transmit an optical beam in line with the recoding layer or layers of the optical recording medium, it is possible to irradiate an appropriate amount of laser light to an optical pickup device without increasing laser noise.

It is preferable to arrange the optical pickup device of the present invention so that the light transmitting member is a polarization diffraction element which includes at least two areas having different duty ratios.

Here, “duty ratio” is a ratio of a groove width to a grating groove interval of a diffraction grating.

With the arrangement, the light transmitting member is a polarization diffraction element including at least two areas having different duty ratios.

For example, if a light beam from a light source is incident to an area having 50% duty ratio, then it is possible to generate 0 order diffraction light and ± first order diffraction light in line with a polarization direction of the light beam. On the other hand, if a light beam from a light source or a light beam reflected by an optical recording medium is incident to an area whose duty ratio is other than 50% (e.g. an area in which grating grooves are not provided), then it is possible to generate only 0 order diffraction light regardless of a polarization direction of the light beam.

As described above, areas having different duty ratios are provided, so that it is possible to adjust an amount of ± first order diffraction light. Here, if ± first order diffraction light is not used for recording/reading a signal and only 0 order diffraction light is used for recording/reading a signal, then it is possible to control light transmittance in line with an amount of ± first diffraction light. Consequently, by causing areas having different light transmittances to transmit a light beam in line with a recording layer or recording layers of the optical recording medium, it is possible to irradiate an appropriate amount of a light beam to the optical recording medium without increasing laser noise.

Further, it is possible to reduce astigmatism due to a diffraction element, so that it is possible to record/reproduce information to/from an optical recording medium with higher accuracy.

It is preferable to arrange the optical pickup device of the present invention so as to further include switching means for switching between at least two areas of the light transmitting member, for example, at least two areas having different light transmittances or duty ratios.

With the arrangement, the optical pickup device of the present invention further includes switching means for switching between at least two areas, having different light transmittances or duty ratios, of the light transmitting member, so that it is possible to set the light transmittances of the light transmitting member to have different values in line with the state of the optical recording medium.

It is preferable to arrange the optical pickup device of the present invention so that the light transmitting member is movable in parallel to a direction in which the light transmitting member is inclined to the optical axis.

For example, there is a case where the light transmitting member preferably includes areas having different patterns so as to reproduce information from an optical recording medium with high accuracy.

With the arrangement of the present invention, the light transmitting member is movable in parallel to a direction in which the light transmitting member is inclined to the optical axis, so that it is possible to dispose each of the areas having different patterns at an effective light flux area of a light beam in line with the optical recording medium.

It is preferable to arrange the optical pickup device of the present invention so that the light splitting means is provided between the light source and the collimator lens.

With the arrangement, the light splitting means is provided between the light source and the collimator lens, so that it is possible to shorten a distance between the collimator lens and an objective lens. Consequently, it is possible to downsize an optical pickup device.

It is preferable to arrange the optical pickup device of the present invention so that the light transmitting member is a ¼ wavelength plate for shifting a phase of an incident light beam by ¼ wavelength, and the light transmitting member is provided between the light splitting means and the collimator lens.

For example, in a case where the light splitting means separates a light beam which is light reflected by an optical recording medium from a light beam which is light emitted by a light source, it is necessary to cause the beams to have different polarization directions. At that time, the polarization directions of the beams are converted by use of a ¼ wavelength plate. The ¼ wavelength plate is a phase contrast plate for shifting a phase of incident light by ¼ wavelength so as to convert circularly polarized light into linearly polarized light and to convert linearly polarized light into circularly polarized light.

With the arrangement of the present invention, the light transmitting member is a ¼ wavelength plate, which is used to shit a phase of an incident light beam by ¼ wavelength and which is provided between the light splitting means and the collimator lens. Consequently, it is possible to convert polarization directions of emitted light and reflected light by use of the ¼ wavelength plate. Therefore, it is possible for the light splitting means to separate the emitted light from the reflected light.

Here, in a case where the ¼ wavelength plate is provided at a collimated light flux for example, if the ¼ wavelength plate is inclined, then only a light path (optical axis) changes, so that it is difficult to correct astigmatism. On the other hand, with the arrangement of the present invention, the ¼ wavelength plate is provided between the light splitting means and the collimator lens (at a converged light path), so that it is possible to correct astigmatism. Consequently, the optical pickup device allows for reducing an influence of astigmatism due to a diffraction element without providing additional elements.

It is preferable to arrange the optical pickup device of the present invention so that the diffraction element is a polarization diffraction element.

With the arrangement, the diffraction element is a polarization diffraction element. Consequently, for example, the diffraction element can diffract a light beam which is linearly P-polarized light and transmit a light beam which is linearly S-polarized light, and the diffraction element can diffract a light beam which is linearly S-polarized light and transmit linearly P-polarized light. The P-polarized light and the S-polarized light are linearly polarized light perpendicular to each other. In other words, it is possible to control transmission and diffraction of a light beam in line with a polarization direction of the light beam. Consequently, it is possible to transmit/diffract only a light beam having a desired polarization direction out of light beams which are light from a light source and light reflected by an optical recording medium. Therefore, it is possible for light splitting means such as a polarizing beam splitter to separate the beams.

The present invention allows for reducing an influence of astigmatism due to a diffraction grating, and therefore the present invention is applicable to an optical pickup device for recording/reading information to/from an optical disc with high density and large capacity.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An optical pickup device, comprising: a light source; a collimator lens; a diffraction element capable of changing light intensity distribution of a light beam emitted by the light source; and light splitting means for causing a light beam reflected by an optical recording medium to be directed in a direction different from a direction of the light beam emitted by the light source,
said optical pickup device further comprising a light transmitting member for compensating astigmatism due to the diffraction element, the light transmitting member being provided between the light source and the collimator lens so as to be inclined to an optical axis of the light source.

2. The optical pickup device as set forth in claim 1, wherein the light transmitting member is arranged so that an angle of inclination of the light transmitting member is adjustable.

3. The optical pickup device as set forth in claim 1, wherein the light transmitting member is a parallel plate.

4. The optical pickup device as set forth in claim 1, wherein the light transmitting member is a ½ wavelength plate for shifting a phase of an incident light beam by ½ wavelength.

5. The optical pickup device as set forth in claim 1, wherein the light transmitting member includes at least two areas having different light transmittances.

6. The optical pickup device as set forth in claim 1, wherein the light transmitting member is a polarization diffraction element which includes at least two areas having different duty ratios.

7. The optical pickup device as set forth in claim 5, further comprising switching means for switching between said at least two areas of the light transmitting member.

8. The optical pickup device as set forth in claim 7, wherein the light transmitting member is movable in parallel to a direction in which the light transmitting member is inclined to the optical axis.

9. The optical pickup device as set forth in claim 1, wherein the light splitting means is provided between the light source and the collimator lens.

10. The optical pickup device as set forth in claim 9, wherein the light transmitting member is a ¼ wavelength plate for shifting a phase of an incident light beam by ¼ wavelength, and the light transmitting member is provided between the light splitting means and the collimator lens.

11. The optical pickup device as set forth in claim 1, wherein the diffraction element is a polarization diffraction element.
